(19) United States
(12) Patent Application Publication
(10) Pub. No.: US 2012/0164448 A1
(43) Pub. Date: Jun. 28, 2012

(54) SHORT CARBON FIBER BUNDLE DISPERSION METHOD AND SHORT CARBON FIBER FINE BUNDLE MADE BY THE SAME

(76) Inventors: PAO-HWA YU, Taipei City (TW); YUN-PING WANG, Taipei City (TW); CHUNG-HUA CHEN, Taoyuan City (TW)

(21) Appl. No.: 12/978,636

(22) Filed: Dec. 27, 2010

(51) Int. Cl. D02G 3/02; D02G 3/36; B05D 3/02

(52) U.S. Cl. 428/368; 427/228

(57) ABSTRACT

A carbon fiber bundle dispersion method, which sequentially includes the following steps: a degumming step, an oxidation step, a surface impurity removing step, a film forming step, a first baking step, a carbonization reaction step, a slight acid neutralization step, an alkaline matter rinsing step, a second baking step and a rubbing step. Through the present invention, a carbon fiber bundle can be dispersed into thinner carbon fiber fine bundles, without need to be soaked in a special liquid to keep their dispersion state. In an ordinary air, the respective carbon fiber fine bundles can still maintain a separation state relative to each other, and thus are convenient to be used in a subsequent mixing process.

### BACKGROUND OF THE INVENTION

(a) Technical Field of the Invention

The present invention relates to a short carbon fiber bundle dispersion method. More particularly, the present invention relates to a carbon fiber bundle dispersion method capable of maintaining a dispersion state.

(b) Description of the Prior Art

A short carbon fiber is a high-performance fiber, which may be fabricated into many carbon fiber reinforced composites including carbon fiber paper, carbon fiber reinforced concrete, and metal or ceramic based carbon fiber reinforce material etc., and may also be used as a functional material like a screening material, heat-generating material, conductive material, chemical filtering material etc. Thus, the carbon fiber has a wide application, for instance, in the electronic industry, battery industry and chemical industry as well as communication, national offense, civil health care and so on.

However, the processing of the above carbon fiber reinforce composite products may encounter a common problem, that is, how to uniformly disperse the short carbon fiber bundles into thinner carbon fiber fine bundles or single carbon fiber filaments in a composite matrix or a solution. Since the carbon fiber filaments are hydrophobic and easily bonded to each other, if the carbon fiber filaments are not separated with the special processing, the carbon fibers are hard to exert their functions and their uniformity of dispersion will directly influence the performance of carbon fiber reinforced composities in working.

Several short carbon fiber bundle separation methods currently used in a laboratory are described as follows:

(1) Dry dispersion method: Nano-scale particles with a diameter of 0.01-0.1 μm (e.g. superfine silicon powder) are mixed with degummed short carbon fiber bundles, so that the nano-scale particles are dispersed on the surface of a single carbon fiber filament to reduce its surface tension. This method has two defects: (a) the nano-scale particles cannot be uniformly dispersed on the surface of the single carbon fiber filament, so the performance is poor; and (b) these nano-scale particles will be added into the composite matrix with dispersed short carbon fiber, and will affect the performance of composite.

(2) Wet dispersion method: A dispersion agent is dissolved into a solution, and after short carbon fiber bundles are added, stirring is continuously conducted or ultrasound oscillation dispersion is performed to form a solution in which the short carbon fiber bundle is uniformly dispersed into short fine carbon fiber fine bundles or filaments. However, the defect lies in that the carbon fiber fine bundles must be placed in the solution to maintain the dispersion state; the solution indirectly restricts the applicable method and range, so the method is not beneficial to the use of the dispersed short carbon fiber fine bundles. The addition of the dispersion agent may negatively affect the strength of a composite material. Moreover, the method using the solution for dispersion does not allow massive prefabrication, storage and transportation and cannot be directly used in many processes for fabricating the composite material, and thus the method is not beneficial to the popularization.

(3) Surface treatment modification method: In chemical and physical ways, generally there are surface oxidation method (including liquid-phase oxidation, vapor-phase oxidation and electro-chemical oxidation), plasma treatment method, surface agent coating method, etc., and affections of these methods are: (a) microholes and etched grooves are formed on the smooth surface of a carbon fiber to increase the specific surface area and generate a surface form adapted for adhering, thereby reducing the surface tension of the carbon fiber and enhancing the interface bonding force between the carbon fiber and another basal body. (b) A polar or reactive function group is introduced or grafted on the surface of the carbon fiber, thereby enhancing the surface activity and increasing the chemical bonding force between the carbon fiber and another basal body.

The surface treatment modifying method usually needs a heating process at a high temperature of 400° C. or above, a high-energy plasma treatment process, or high pollution or expensive chemical materials like strong acid and alkali, phosphide (e.g. phosphoric acid, meta-phosphoric acid, triammonium phosphate and ammonium phosphate), noble metal ion catalyst (Ag, Pt and Pd ions), etc., so this method causes environmental pollution and also is not applicable to mass production due to the equipment prices and material costs as well as other factors.

### SUMMARY OF THE INVENTION

In view of the above problems, the present invention provides a short carbon fiber bundle dispersion method, in which a short carbon fiber bundle can be dispersed into carbon fiber fine bundles or filaments but without above defects. When the method is performed on the same carbon fiber bundle repeatedly, the carbon fiber bundle may be dispersed into carbon fiber fine bundles or filaments, and keep the dispersion state without being soaked into a special liquid. Furthermore, the present invention does not use a toxic or volatile organic solvent, strong acid or strong alkali, and both the dispersion agent and high-molecular film forming agent used are both non-ionic agents, thereby avoiding reaction with the metal salts or ion organic compounds in the fabricating process. Therefore, the present invention does not need an expensive equipment appliance and also does not affect the environment, so the method is applicable to mass production.

The short carbon fiber bundle dispersion method of the present invention sequentially includes the following steps: (a) a degumming step, (b) an oxidation step, (c) a surface impurity removing step, (d) a coating step, (e) a first baking step, (f) a carbonization reaction step, (g) a slight acid neutralization step, (h) an purification rinsing step, (i) a second baking step, and (j) a machine-made dispersion step.

In the degumming step, the expoxy glue on the short carbon fiber bundle is removed. In the oxidation step, the carbon fiber bundle is oxidized. In the surface impurity removing step, the carbon fiber bundle is rinsed in the deionized water to remove an impurity on the surface of the carbon fiber bundle. In the coating step, the carbon fiber bundle is soaked into a solution and is stirred, wherein the solution includes the content serving as both a dispersion agent and a coating agent, the carbon fiber bundle is dispersed into a plurality of carbon fiber fine bundles or filaments through the dispersion agent, and through the coating agent, the carbon fiber fine bundles are respectively formed with a layer of high molecular polymer film thereon. In the first baking step, the pulpy carbon fiber fine bundles or filaments are firstly screened from the solution to form the thin layer and then baked at a temperature higher than a curing temperature of the high molecular polymer film, so that the high molecular polymer film is cured. In the carbonization reaction step, the baked carbon fiber fine bundles go through a vapor-phase oxidation reaction at a temperature higher than a carbonization temperature of the high molecular polymer film, so that, after the high molecular polymer films go through the vapor-phase oxidation reaction, a plurality of carbon-based function groups are formed on a surface of the short carbon fiber fine bundles or filaments. In the slight acid neutralization step, the fiber fine bundles are immersed in a slight alkaline water solution to neutralize acid materials on the surface caused by the carbonization and remove loose impurities on the surface. In the purification rinsing step, the fiber fine bundles or filaments are firstly immersed in the neutral deionized water, and then screened from the water to form the pulpy thin layer. In the second baking step, the pulpy thin layer of fiber fine bundles or filaments are baked and subjected to a vapor oxidation at a temperature lower than 400° C. In the machine-made dispersion step, the dried thin layer of fiber fine bundles or filaments are opened and rubbed to get dispersed.

With the above steps of the method, the original gathered short carbon fiber bundles can be dispersed into carbon fiber fine bundles or filaments and can be maintained in the dispersion state for shipment and application.

Therefore, when used in another base material to make short carbon fiber reinforced composities, the proportions are easier to control and the carbon fiber fine bundles can be easily uniformly distributed in the base material. Moreover, when the method of the present invention is performed on the same group of carbon fiber bundles repeatedly, thinner carbon fiber fine bundles may be formed successively until they are dispersed into carbon fiber filaments, so the method is more convenient to be used in various mixing applications.

### BRIEF DESCRIPTION OF THE DRAWINGS

FIG. 1 is a schematic view of a process according to an embodiment of the method of the present invention;

FIG. 2 is a schematic sectional view of a chopped carbon fiber scattering machine;

FIG. 3 is a schematic top view of horizontal bars of the chopped carbon fiber scattering machine; and

FIG. 4 is a schematic stereogram of carbon fiber fine bundles obtained according to the method of the present invention.

### DETAILED DESCRIPTION OF THE PREFERRED EMBODIMENTS

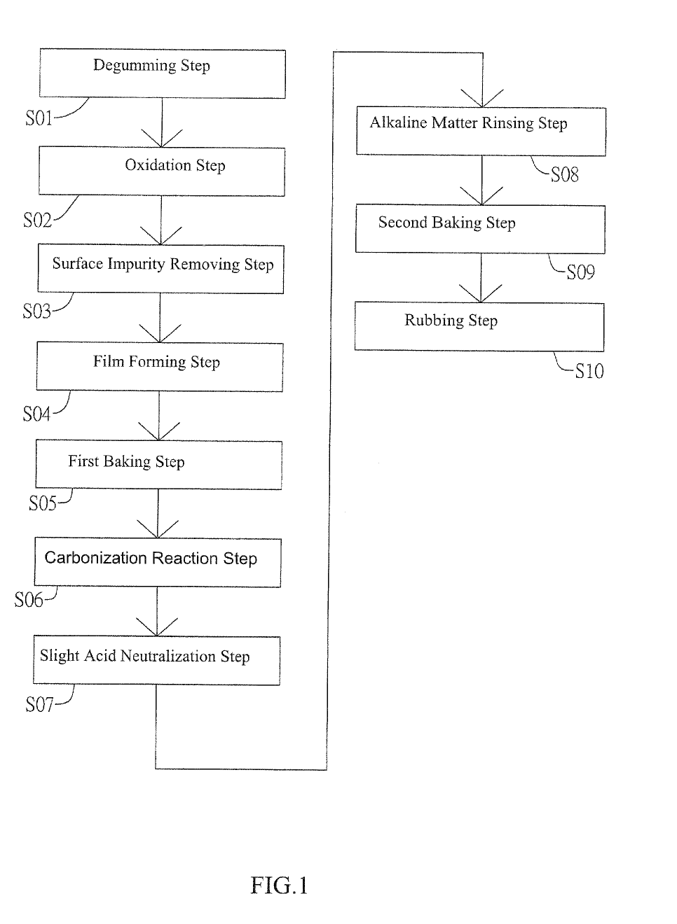

Referring to FIG. 1, the carbon fiber bundle dispersion method of this embodiment sequentially includes the following steps: (a) a degumming step S01, (b) an oxidation step S02, (c) a surface impurity removing step S03, (d) a coating step S04, (e) a first baking step S05, (f) a carbonization reaction step S06, (g) a slight acid neutralization step S07, (h) an purification rinsing step S08, (i) a second baking step S09, and (j) a machine-made dispersion step S10. In the embodiment of the present invention, for example, a short carbon fiber bundle forms a plurality of short carbon fiber fine bundles or filaments. However; the present invention in practical use does not have limitation on the quantity and may be carried out on a plurality of fiber bundles.

In the degumming step S01, an expoxy glue on a carbon fiber bundle is removed. Also, in the degumming manner, the carbon fiber bundle is wetted by the neutral deionized water and then heated at a temperature between 230° C. and 300° C. for 1 hour, and thus a resin and other impurities contained in the carbon fiber bundle can be removed. In addition, other conventional degumming manners may be used, which are not limited to the above.

In the oxidation step S02, the carbon fiber bundle after the degumming step S01 is oxidized. In this embodiment, a vapor-phase oxidation method may be used to perform oxidation by the medium of dry air or the 0.5-3% (by volume) ozone-air mixture, and a temperature of the vapor-phase oxidation may be between 275° C. and 400° C. However, other oxidation methods may also be used.

In the surface impurity removing step S03, the oxidized carbon fiber bundle is rinsed to remove an impurity on the surface of the carbon fiber bundle.

In the coating step S04, the carbon fiber bundle is soaked in a solution and is stirred, wherein the solution includes a dispersion agent and a film forming agent. The dispersion agent may disperse the carbon fiber bundle into a plurality of carbon fiber fine bundles, and the film forming agent makes the carbon fiber fine bundles respectively formed with a layer of high molecular polymer film thereon. In this embodiment, an ultrasound oscillation or other stirring equipment may be used to perform high-speed stirring, and the stirring speed is preferably higher than 300 revolutions per minute, and the power of the ultrasound oscillation may be 40 W per liter to 60 W per liter. Moreover, the dispersion agent and the film forming agent used in the solution is the non-ionic modified cellulose, which may be Hydroxypropyl Methyl Cellulose (HPMC), Methyl Cellulose (MC), Carboxymethyl Cellulose (CMC), Hydroxyethyl Cellulose (HEC) or Poly Vinyl Pyrrolidone (PVP), the viscosity of solution shall be not higher than 50 mPa·s, the gel temperature of the solution is greater than 80° C. (preferably 80° C. to 100° C.), and its carbonization temperature is greater than 250° C.

In the first baking step S05, the carbon fiber fine bundles are baked at a temperature higher than a curing temperature of the high molecular polymer film, so that the high molecular polymer film is cured. Further, the carbon fiber fine bundles after the first baking step S05 form floccules.

In the carbonization reaction step S06, the dried carbon fiber fine bundles or filaments with coating are subjected to a vapor-phase oxidation reaction at a temperature higher than a carbonization temperature of the high molecular polymer film by the oxidation medium of dry air or the 0.5-3% (by volume) ozone-air mixture, so that the high molecular polymer films after the vapor oxidation reaction form a plurality of carbon-based function groups on a surface of the carbon fiber fine bundles or filaments, and the carbon-based function groups are attached to the surface of the carbon fiber bundle or filaments, so as to form a convex and concave shape on the surface of the carbon fiber fine bundles. Further, in the carbonization reaction step S06, the temperature is preferably between 275° C. than 400° C.

In the slight acid neutralization step S07, the baked fiber fine bundles are immersed in a slight alkaline water solution, for neutralizing the slight acid produced when the high molecular polymer is decomposed and removing the unstable function groups and impurities on the surface.

In the purification rinsing step S08, the fiber fine bundles after being subjected to the slight acid neutralization step S07 are immersed in a neutral deionized water, for rinsing alkaline matters, and then are screened from the water to form the pulpy thin layer.

In the second baking step S09, the pulpy thin layer of fiber fine bundles or filaments are baked at a temperature preferably between 275° C. than 400° C., and subjected to a vapor-phase oxidation by the oxidation medium of dry air or the 0.5-3% (by volume) ozone-air mixture, wherein the carbon fiber fine bundles or filaments form floccules after this step.

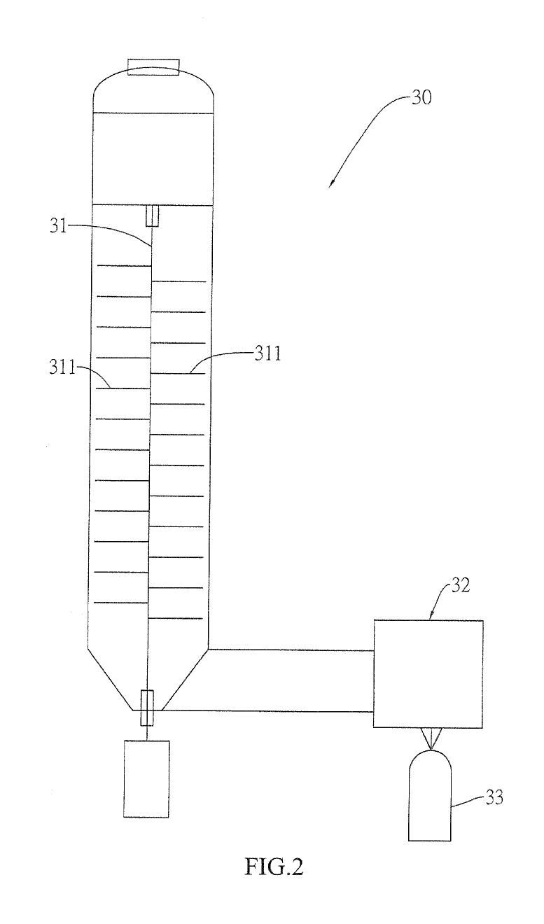

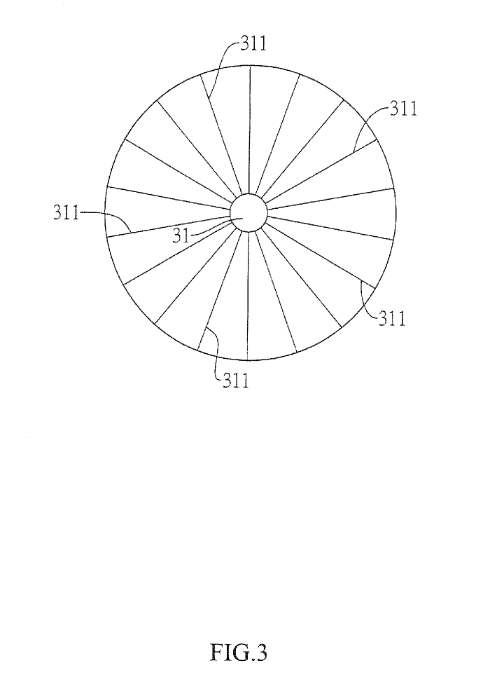

In the machine-made dispersion step S10, the dried floccules of short carbon fiber fine bundles or filaments after the second baking step S09 are opened and rubbed for more fine dispersion. In this step, a chopped carbon fiber scattering machine may be used for opening and rubbing, or the opening and rubbing is performed directly by manual. Referring to the chopped carbon fiber scattering machine 30 as shown in FIG. 2 and FIG. 3, the chopped carbon fiber scattering machine 30 uses multiple horizontal bars 311 (or horizontal wires (filaments), e.g. piano wires or high strength nylon wires) fixed to a vertical spindle 31 to perform opening and rubbing for scattering. When the vertical spindle 31 rotates at a high speed, the horizontal bars 311 form multiple groups of rotation spiral planes, thus the flocculent carbon fiber fine bundles moving along the parallel rotating axis direction will be opened and rubbed for further dispersing. Meanwhile, by use of a forced airflow produced by vacuum aspiration from a fiber separator 32 arranged on the outlet of the chopped carbon fiber scattering machine 30, the flocculent carbon fiber fine bundles will be forced to move parallel to the vertical spindle 31 downwards and pass through multiple groups of beating rotation spiral planes, and at last the fiber separator 32 collects the dispersed carbon fiber fine bundles or filaments from the exhausted airflow and then the dispersed carbon fiber fine bundles or filaments will be stored in a storage bag 33, and thus the carbon fiber fine bundles of the rubbing step S10 are obtained.

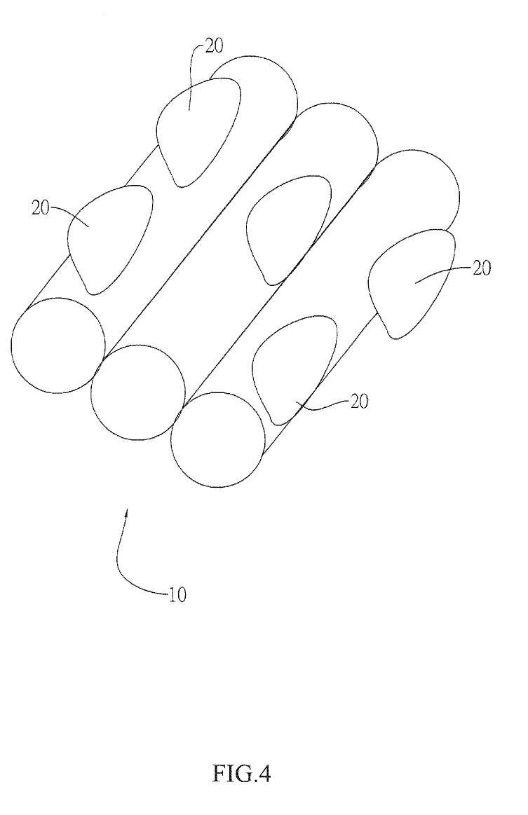

As shown in FIG. 4, after being treated according to the steps of the method of this embodiment, the original gathered carbon fiber bundle is dispersed to form carbon fiber fine bundles 10, wherein the surface of each carbon fiber fine bundle 10 is attached with a carbonized high molecular polymer 20. Furthermore, if the above steps are performed on the same group of carbon fiber bundles repeatedly, the carbon fiber bundles gradually become thinner. Additionally, the carbon fiber fine bundles after being treated through this embodiment are placed in a vacuum bag or nitrogen gas bag to prevent moisture from adhering to the surface of the carbon fiber fine bundles.

The method according to the embodiments of the present invention can make a gathered carbon fiber bundle dispersed into thinner carbon fiber fine bundles, and the carbon fiber fine bundles can maintain a dispersion state in the air. Therefore, when the carbon fiber fine bundles are used together with another base material, the quantity is easy to control and the carbon fiber fine bundles can be dispersed in the base material. Furthermore, if the method of the present invention is performed on the same group of carbon fiber bundles repeatedly, thinner carbon fiber fine bundles can be formed successively until they are dispersed into carbon fiber filaments, and thus the method can be performed for a variety of applications.

I claim:

1. A carbon fiber bundle dispersion method, comprising the following steps sequentially:
(a) a degumming step: removing a glue on a carbon fiber bundle;
(b) an oxidation step: oxidizing the carbon fiber bundle;
(c) a surface impurity removing step: rinsing the carbon fiber bundle to remove an impurity on a surface of the carbon fiber bundle;
(d) a coating step: soaking the carbon fiber bundle in a solution and conducting stirring, wherein the solution comprises a dispersion agent and a film forming agent, the carbon fiber bundle is dispersed into a plurality of carbon fiber fine bundles through the dispersion agent, and the carbon fiber fine bundles are respectively formed with a layer of high molecular polymer film thereon through the film forming agent;
(e) a first baking step: baking the carbon fiber fine bundles at a temperature higher than a curing temperature of the high molecular polymer film, so as to cure the high molecular polymer film;
(f) a carbonization reaction step: performing a vapor-phase oxidation reaction on the baked carbon fiber fine bundles at a temperature higher than a carbonization temperature of the high molecular polymer film, so that after the high molecular polymer films go through the vapor-phase oxidation reaction, a plurality of carbon-based function groups are formed on a surface of the carbon fiber fine bundles;
(g) a slight acid neutralization step: immersing the fiber fine bundles in a slight alkaline water solution;
(h) an purification rinsing step: immersing the fiber fine bundles in a neutral deionized water;
(i) a second baking step: performing baking and vapor-phase oxidation on the fiber fine bundles at a temperature lower than 400° C.; and
(j) a machine-made dispersion step: rubbing and dispersing the fiber fine bundles.

2. The carbon fiber bundle dispersion method of claim 1, wherein the degumming step comprises heating at a temperature of 250° C. for 1 hour after immersing in the neutral deionized water.

3. The carbon fiber bundle dispersion method of claim 2, wherein the oxidation step is performed through a vapor-phase oxidation method.

4. The carbon fiber bundle dispersion method of claim 3, wherein the film forming step utilizes ultrasound oscillation for stirring.

5. The carbon fiber bundle dispersion method of claim 4, wherein the carbon fiber fine bundles form floccules after the first baking step.

6. The carbon fiber bundle dispersion method of claim 5, wherein the carbon-based function groups form a convex and concave shape on the surface of the carbon fiber bundle.

7. The carbon fiber bundle dispersion method of claim 6, wherein the carbonization reaction step is performed at a temperature lower than 400° C.

8. The carbon fiber bundle dispersion method of claim 7, wherein the rubbing step utilizes a chopped carbon fiber scattering machine for rubbing.

9. The carbon fiber bundle dispersion method of claim 8, wherein the carbon fiber bundles form floccules after the second baking step.

10. The carbon fiber bundle dispersion method of claim 9, wherein the solution is a non-ionic modified cellulose.

11. The carbon fiber bundle dispersion method of claim 10, wherein the solution is a 2% (wt) solution with a viscosity not higher than 50 mPa·s, a gel temperature of the solution is greater than 80° C., and its carbonization temperature is greater than 250° C.

12. The carbon fiber bundle dispersion method of claim 11, wherein the non-ionic modified cellulose is Hydroxypropyl Methyl Cellulose (HPMC), Methyl Cellulose (MC), Carboxymethyl Cellulose (CMC), Hydroxyethyl Cellulose (HEC) or Poly Vinyl Pyrrolidone (PVP).

13. The carbon fiber bundle dispersion method of claim 12, wherein a temperature for performing the vapor-phase oxidation is between 275° C. and 400° C.

14. A carbon fiber fine bundle, treated according to the method of claim 1, wherein a surface of each carbon fiber fine bundle is attached with a carbonized high molecular polymer.
